(19) United States
(12) Patent Application Publication
(10) Pub. No.: US 2004/0136524 A1
(43) Pub. Date: Jul. 15, 2004

(54) Communications device wall mounting adapter and jack conversion unit apparatus

(76) Inventor: Ronald W. Bliss, Palm Coast, FL (US)

Correspondence Address: RONALD W. BLISS, 64 RYMSHAW DR., PALM COAST, FL, 32164, US

(21) Appl. No.: 10/624,749

(22) Filed: Jul. 22, 2003

Related U.S. Application Data
(60) Provisional application No. 60/402,809, filed on Aug. 12, 2002.

(51) Int. Cl. H04M 1/00; H04M 9/00

(52) U.S. Cl. 379/435

(57) ABSTRACT

Disclosed is a communications device wall mounting adapter unit to be used for wall mounting a telephone instrument, cordless telephone base unit, or other communications device that has telephone standard mounting slots to affix to an existing flush wall jack converting it to a wall mount apparatus or as a stand alone unit comprising: a base plate having at least one centrally located rectangular hole; four extended sidewalls creating a cavity on the back side of tine plate; two screw or nail head type studs, each having a shank portion being in connection with the plate and the screw or nail head type portion extending above the plate; and, a plurality of horizontal and parallel slots and holes which can accept fastening devices.

### FIELD OF INVENTION

The invention relates to the field of telephone apparatus, specifically a communications device wall mounting adapter and Jack conversion unit.

### DESCRIPTION OF PRIOR ART

Prior art relating to wall mounting is exemplified by FIG. 1 of U.S. Pat. No.3,990,764. In such a disclosure, a two part wall mounting assembly is shown with nail head like studs for attaching the telephone to the assembly, which is also a jack containing a modular connection, which is not the case with the communications device conversion unit. This is also the same situation as with FIG. 1 of U.S. Pat. No. 4,146,292 which also is a jack assembly containing a modular connection.

### SUMMARY OF THE INVENTION

Disclosed is a communications device wall mounting adapter and jack conversion unit apparatus. The object of the invention is to provide an easy, simple, time saving way of wall mounting a telephone, cordless phone base unit, or other communications related apparatus that has standard telephone wall mounting slots. Used in conjunction with an existing modular jack and modular cord, the invention is attachable to either a flush wall jack, a wall box, or to a wall without the need of installing a separate modular plug connector wall jack, thus providing simplicity and time savings to the consumer or telephone equipment installer by not requiring special tools, re-wiring, or telephone modular jack installation skills.

### BRIEF DESCRIPTION OF THE DRAWINGS

FIG. I, 8 shows an existing wall jack. Number 1 is an exploded view of the communications device wall mounting adapter and jack conversion unit lining up with the existing wall jack for easy installation to convert a wall jack into a wall mounting for a communications device. 5 are the side walls extending vertically from and around the periphery creating a cavity on the back side of the invention which will cover/enclose an existing wall jack. 2 shows the screw or nail head type studs for attaching the communications device. 3 allows the screw head of the existing wall jack to go through the wall mounting adapter invention thus allowing the re-use of the existing wall jack screws to attach the wall mounting adapter invention to it. 6 is a channel for sliding the invention along the shank portion of the screw to the center slot thus making it possible in some installations to install the invention without totally removing the existing wall jack screws. 7 fastener slots which are designed to line up with a standard wall box housing and wall jack or a stand alone unit. 4 is an opening hole which allows the easy access to the modular connector on the wall jack, wall box which can contain another type modular connector, and also allows for the storage of excess line cord.

FIG. 2 is a bottom view of the invention showing slots 9, as an alternate route for the cord access when the wall mounting adapter is used as a stand alone unit. This allows the cord 10 to be connected to the telephone apparatus from an existing jack such as a surface mounted jack in FIG. 3. via a modular connection 11.

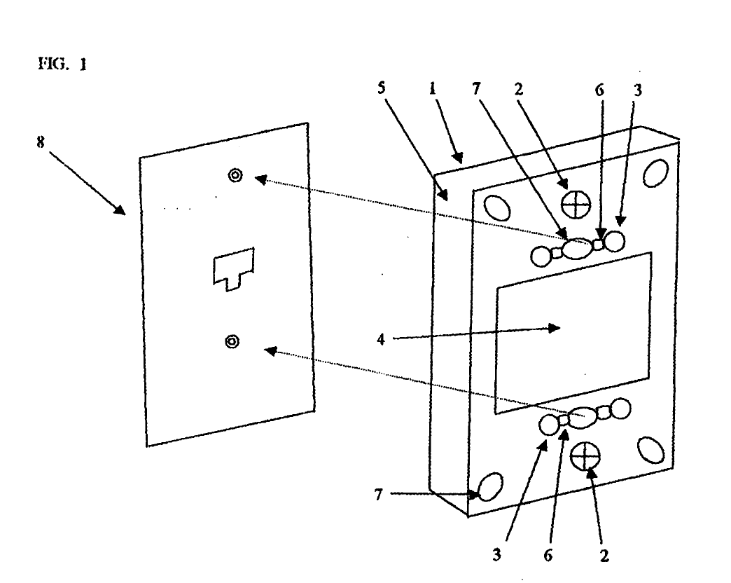

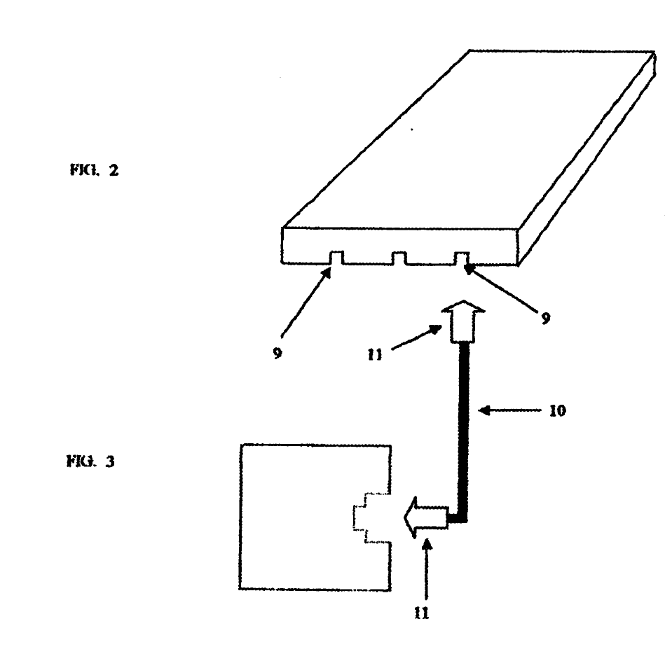

1. A communications device wall mounting adapter and jack conversion unit comprising: (a) base plate having at least 1 rectangular hole therein; (b) plate having extended walls integrally connected thereto and extending vertically from and around its periphery thus creating a cavity on the back side of the plate. (c) at least two screw or nail head type studs each having a shank portion being in connection with the plate and the screw or nail head like portion extending above the plate. (d) a plurality of horizontal and parallel slots and holes which can accept various fastening devices; a flat portion on the back which can accept double-sided tape or other means of fastening to an existing flush wall jack or fastening as a stand alone unit.
